(19) United States
(12) Patent Application Publication
(10) Pub. No.: US 2009/0100149 A1
(43) Pub. Date: Apr. 16, 2009

(54) Method and system for using tokens to conduct file sharing transactions between handhelds and a web service

(76) Inventors: Greg Arnold, Sunnyvale, CA (US); Dan Torres, San Carlos, CA (US)

Correspondence Address: WAGNER, MURABITO & HAO LLP, Third Floor, Two North Market Street, San Jose, CA, 95113, US

(21) Appl. No.: 09/863,232

(22) Filed: May 21, 2001

(51) Int. Cl. G06F 15/16

(52) U.S. Cl. 709/219

(57) ABSTRACT

A method and system supporting web file sharing transactions via a networked handheld computer system. In a system having a server that automatically detects when new versions of currently used applications are made available for a networked handheld computer system, a method is described for allowing one handheld computer system to facilitate the transfer of a file to another handheld computer system using the server. On the server, each registered handheld has account information indicating the applications (and versions) that it supports. As part of the file sharing transaction, using a token, a sending handheld computer system updates the account information of a receiving handheld to indicate that a download is required the next time the receiving handheld is networked with the server. A new file name may be recorded in the account information, or, a new version of an existing file name may be updated. The new information is then automatically downloaded to the receiving handheld during its next synchronization with the server. Security options on the receiver are available that restrict which handhelds have authority to send files to the receiving handheld. Synchronization can be performed with a host computer system, or directly between the server and the handhelds. The shared file may be any information, e.g., an application, data, images, electronic currency, etc.

### BACKGROUND OF THE INVENTION

1. Field of the Invention

The present invention relates to the field of electronic communication and data processing. More specifically, embodiments of the present invention relate to methods and systems which expand the available ways for two or more portable computer systems to exchange and share information.

2. Related Art

As the components required to build a computer system have reduced in size, new categories of portable electronic devices and computer systems have emerged. One of the new categories is the “palmtop” computer system. A palmtop computer system is a computer that is small enough to be held in the hand of a user and can therefore be “palm-sized.” Most palmtop computer systems are used to implement various Personal Information Management (PIM) applications such as an address book, a daily organizer (calendar, datebook, etc.) and electronic notepads, to name a few. Palmtop computers with PIM software have been known as Personal Digital Assistants (PDAs). Many PDAs have a small and flat display screen associated therewith. Moreover, PDAs and cell phone technology are being integrated together resulting in a single intelligent device that provides wireless communication capability.

User convenience and device value are very important factors for portable electronic devices and systems that may include portable electronic devices. Typically, portable electronic devices are employed while the user is on the run, e.g., in business meetings, on business travel, personal travel, in a vehicle, on foot, etc. Because the user may be occupied or busy while using the portable electronic device, the number of user steps or user tasks required to access information from an electronic device (or to store information into the electronic device) is crucial for producing a commercially successful product. That is, the more difficult it is to access data from an electronic device, the less likely the user will perform those tasks to obtain the information. Likewise, the easier information is to obtain, the more likely the portable electronic device will be used to obtain that information and the more likely the portable electronic device will become a part of the user's everyday activities. Similarly, the more useful the device, the more the device will be used and acquired.

The portability and convenience of palmtops has made it increasingly desirable to increase the number and types of applications that can run on them. It is advantageous to expand the capabilities of a palmtop so that it can provide many of the same, if not the same, services provided by a desktop or laptop computer system, particularly with regard to access to the World Wide Web. As such, information currently available via the Internet using personal computers, such as on-line access to news and financial information, can also be provided via a palmtop. In addition, a palmtop can be used for electronic mail (“e-mail”) and multi-player gaming, and features such as voice recognition can also be added.

It has proven convenient to allow handheld computer systems to share files directly with each other. In the past, some handheld computer systems have been implemented with short range, point-to-point communication ports. One such wireless point-to-point communication mechanism uses infra-red (IR) technology and is called “beaming.” Using IR technology, the sending device and the receiving device are generally placed in close proximity with each other and the IR are oriented such that each is directed toward the other. A point-to-point transaction can then occur. While this communication method has many advantages, it is also disadvantageous because it requires the sender and the receiver to be in close proximity to each other and also because it does not allow other devices to easily share in the transaction. In addition to both devices being in the same proximity, the transaction is conducted in a symmetrical fashion, e.g., both devices must be present, powered on, ready to receive beamed data, etc.

Web or networked sharing has been used for file transactions between two or more devices that are not local. Web or networked sharing involves a server acting as an intermediary between the sender and the receiver. Heretofore, networked sharing among handheld computer systems has proven inconvenient for a number of reasons. In order for a receiving device to locate a file, a host computer system is typically used. The host computer system needs to locate the file, then download the file using a software browser. The file is generally received in a compressed format to decrease the time required for the download. Therefore, the user needs to electronically unpack the file, which requires a second software tool. Then, the user needs to install the unpacked file into a special downloader tool designed for the handheld. The downloader tool, a third software tool, then installs the application on the handheld.

The process for installing an updated application onto a palmtop via the computer system can be somewhat complex. For an occasional user not familiar with the particulars of locating, downloading and decompressing files, or not familiar with the specific hardware and software configurations of his/her palmtop, the task of installing an update may prove to be a difficult challenge. Because of the complexity of the above transaction, and the many different software tools it requires, an impediment exists today for easy networked sharing between handheld devices.

### SUMMARY OF THE INVENTION

Accordingly, what is needed is a system and method for facilitating networked file sharing between two or more handheld computer systems that reduces or eliminates the impediments described above. What is further needed is a solution that is operable within a wired or a wireless network and which operates with or without a host computer system. It is appreciated that embodiments of the present invention provide the above advantages and others not specifically mentioned above but described in the sections to follow.

Generally, embodiments of the present invention allow for a networked handheld to share a file with another handheld device, irrespective of its current proximity or availability to the handheld initiating the sharing (“the sending handheld”). Sharing occurs by the sharing handheld passing a token to a web server. The token contains information regarding the name of the file to be shared along with the identify of the receiving handheld. The token is a compact record which can be transferred over wireless networks in a much more efficient manner than sending the entire file. A variation of this embodiment allows for a networked handheld to share a file directly, by uploading the file from the handheld along with the token. This would occur if the shared file did not already exist on the web service. The token is then used to update the account information of the receiving handheld in order to cause a download to occur between the server and the receiving handheld when the receiver next synchronizes with the server.

A method and system are described herein for supporting web file sharing transactions via a networked handheld computer system. In a system having a server that automatically detects when new files or information are made available for a networked handheld computer system, a method is described for allowing one handheld computer system to facilitate the transfer of a file to another handheld computer system using the server. On the server, each registered handheld has account information indicating the applications (and versions) that it supports and has currently installed.

In one embodiment, the account information includes an application version record that includes, for each entry, the name of the application, its current version number, an identification of the sending device, and a short description of the application or version. As part of the file sharing transaction, using a token, a sending handheld computer system updates the server-account information of a receiving handheld to indicate that a download is required the next time the receiving handheld is networked with the server. A new file name may be recorded in the account information, or, a new version of an existing file name may be updated. The new application is then automatically downloaded to the receiving handheld during its next synchronization with the server.

In another embodiment, an in-box of the handheld receiving a file from another networked handheld is updated to reflect the availability of a new file. The receiving handheld is alerted through a separately defined mechanism that could include email notification, or other altering mechanism. Subsequently, the file is downloaded according to the rules defined by the user in the policy manager.

Policy directives are available that can restrict which users have authority to send files to the receiving user. In one embodiment, the receiver may grant permission to a specific user. In another embodiment, permission may be granted to an entire group of senders, such as a common work group designation. Alternatively, the receiver may require all downloads to be authorized by a direct user confirmation before the operation can be completed. File downloads can be performed “wired” in the cradle with a host computer system, or wireless directly between the server and the handhelds. The invention may be practiced on wired or wireless networks. The shared file may be any binary information, e.g., an application, data, images, etc.

More specifically, an embodiment of the present invention includes a system comprising: a receiver handheld device; a remote server containing an account reserved for the receiver handheld device which describes a complement of information stored in the receiver handheld device; a sender handheld device for requesting the server to add information to the receiver by modifying the receiver's account (e.g., via a token) to identify an information that resides on the remote server but not on the receiver handheld device; wherein the receiver handheld device is for establishing a connection with the remote server; and wherein the remote server is for automatically determining, from the account, that the information is new to the receiver handheld device and automatically for downloading the information to the receiver handheld device.

Embodiments include the above and wherein the sender and the receiver handheld devices are handheld computer systems and wherein the information is a version of an application program and wherein the remote server is a web based server.

Embodiments include the above and wherein the account comprises an application version record table comprising an entry for each application stored in the receiver handheld device and wherein each entry comprises: an application identifier; a version identifier; and an identifier of the device that created the entry.

Embodiments include the above and wherein the remote server is also for determining if the sender handheld device has authority to download to the receiver handheld device as a precursor to downloading the information to the receiver handheld device.

### BRIEF DESCRIPTION OF THE DRAWINGS

FIG. 1A is an exemplary networked system including a handheld computer system that is communicatively coupled to a web based server via a wireless connection without the use of a host computer system.

FIG. 1B is an exemplary networked system including a handheld computer system that is communicatively coupled to a web based server via a host computer system.

FIG. 2A is a top side perspective view of the exemplary portable, e.g., handheld, computer system.

FIG. 2B is a bottom side perspective view of the exemplary handheld computer system.

FIG. 3 is a perspective view of a cradle device for connecting an exemplary handheld computer system to other systems via a communication interface.

FIG. 4 is a logical block diagram of an exemplary handheld computer system in accordance with an embodiment of the present invention.

FIG. 5A and FIG. 5B illustrate an embodiment of the file sharing processes of the present invention using a token.

FIG. 6A is a diagram of a networked system including a web based server and multiple handheld computer systems that may perform file sharing in accordance with embodiments of the present invention.

FIG. 6B is a diagram of a networked system including a web based server, a host computer system and multiple handheld computer systems that may perform file sharing in accordance with embodiments of the present invention.

FIG. 7A illustrates an application version record table for a particular handheld computer system in accordance with an embodiment of the present invention.

FIG. 7B is an example of the application version record table of FIG. 7A.

FIG. 7C illustrates contents of a policy manager for a particular handheld computer system in accordance with an embodiment of the present invention.

FIG. 8 illustrates steps in a process used by a first handheld for performing file sharing with another handheld computer system by giving a file of information in accordance with an embodiment of the present invention.

FIG. 9 illustrates steps in a process used by a second handheld for performing file sharing with a first handheld computer system by receiving a file of information in accordance with an embodiment of the present invention.

FIG. 10 is an exemplary screen display representing a security embodiment employing a user message as a precursor to any file download operation.

FIG. 11 is an exemplary screen display representing a security options embodiment employing various degrees of file download permission.

### DETAILED DESCRIPTION OF THE INVENTION

In the following detailed description of the present invention, a method and system for using tokens to perform file sharing transactions involving a web server and two or more handheld computer systems, numerous specific details are set forth in order to provide a thorough understanding of the present invention. However, it will be recognized by one skilled in the art that the present invention may be practiced without these specific details or with equivalents thereof. In other instances, well known methods, procedures, components, and circuits have not been described in detail as not to unnecessarily obscure aspects of the present invention.

### Notation and Nomenclature

Some portions of the detailed descriptions which follow (e.g., processes 600 and 700) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “checking,” “accessing” or “processing” or “computing” or “suspending” or “resuming” or “translating” or “calculating” or “determining” or “scrolling” or “displaying” or “recognizing” or “executing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Palmtop Computer System Platform

The processes and systems of the present invention described herein are applicable to communication between electronic devices which may include computer systems, portable computer systems, cell phones, pagers, etc. Some portable computer systems called personal digital assistants (PDAs) are handheld. Although applicable across a wide variety of platforms and devices, an embodiment of the present invention is described herein by example using an exemplary portable or mobile computer system, e.g., a PDA.

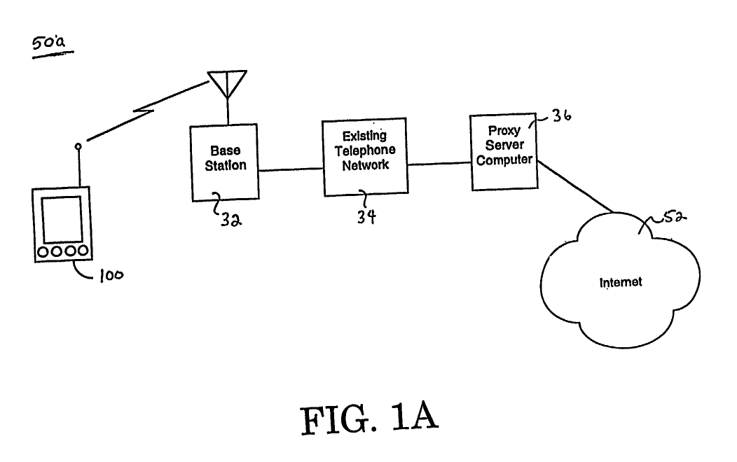

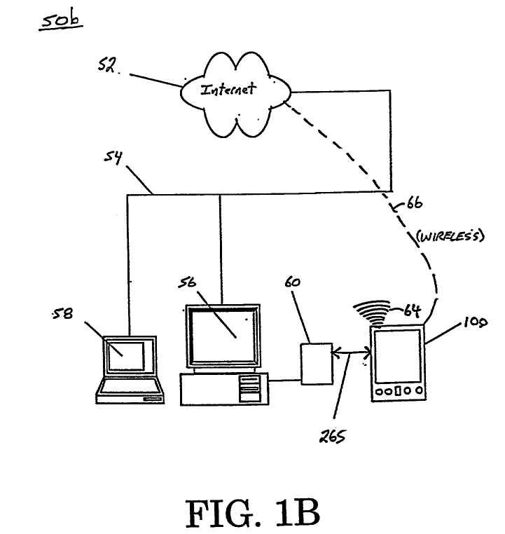

FIG. 1A is a block diagram of an exemplary network environment 50a including a handheld computer system 100. In one embodiment, portable computer system 100 has the ability to transmit and receive data and information over a wireless communication interface (e.g., a radio interface).

Base station 32 may be both a transmitter and receiver base station, which can be implemented by coupling it into an existing public telephone network 34. Implemented in this manner, base station 32 enables handheld computer system 100 to communicate with a proxy server computer system 36, which is coupled by wire to the existing public telephone network 34. Furthermore, proxy server computer system 36 is coupled to the Internet 52, thereby enabling handheld computer system 100 to communicate with the Internet 52. When communicating with a Web site over Internet 52, protocols such as CTP (Compact Transport Protocol) and CML (Compact Markup Language) can be used by portable computer system 100 in the present embodiment.

It should be appreciated that one of the functions of proxy server 36 is to perform operations over the Internet 52 on behalf of handheld computer system 100. For example, proxy server 36 has a particular Internet address and acts as a proxy device for handheld computer system 100 over the Internet 52.

It should be further appreciated that other embodiments of a communications network, planned or envisioned, may be utilized in accordance with the present invention. For example, a wireless connection may be made from handheld computer system 100 directly to the Internet 52.

The data and information which are communicated between base station 32 and handheld computer system 100 are the same type of information and data that can conventionally be transferred and received over a public telephone wire network system. However, a wireless communication interface is utilized to communicate data and information between handheld computer system 100 and base station 32. It should be appreciated that one embodiment of a wireless communication system in accordance with the present invention is the Mobitex wireless communication system. Alternatively, a wireless GSM network may be employed.

FIG. 1B illustrates an exemplary networked system 50b that can be used to provide web server access to handheld computer system 100. In this system 50b, a host computer system 56 is used. Host computer system 56 can either be a desktop unit as shown, or, alternatively, can be a laptop system 58. Optionally, one or more host computer systems can be used within system 50b. Host computer systems 58 and 56 are shown connected to a communication bus 54, which in one embodiment can be a serial communication bus, but could be of any of a number of well known designs, e.g., a parallel bus, Ethernet Local Area Network (LAN), etc. Optionally, bus 54 (or a separate communication channel) can provide communication with the Internet 52 using a number of well known protocols.

A communication link is also coupled to a cradle 60 (or cable dock) for receiving and initiating communication with an exemplary handheld computer system 100 over line 265. Cradle 60 provides an electrical and mechanical communication interface between the computer system 100 for two way communications. In one embodiment, the communication link including cradle 60 and line 265 is a serial communication link or can be a USB link. Computer system 100 may also contain a wireless infrared communication mechanism 64 for sending and receiving information to or from other devices. As discussed more fully below, computer system 100 also contains one or more other wireless communication mechanisms, e.g., cellular phone, Bluetooth and/or wireless LAN (e.g., IEEE 802.11), for instance, all of which can be used to establish the communication link between the portable computer system 100 and the host computer system or with the Internet directly 66 (as shown in FIG. 1A).

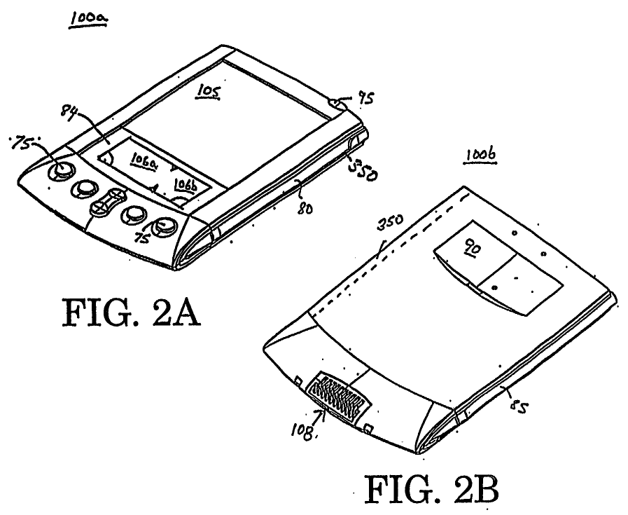

FIG. 2A is a perspective illustration of the top face 100a of one embodiment of the handheld computer system. The top face 110a contains a display screen 105 surrounded by a bezel or cover. A removable stylus 80 is also shown. The display screen 105 contains a transparent touch screen (digitizer) able to register contact between the screen and the tip of the stylus 80. The stylus 80 can be of any material to make contact with the screen 105. As shown in FIG. 2A, the stylus 80 is inserted into a receiving slot or rail 350. Slot or rail 350 acts to hold the stylus when the computer system 100a is not in use. The top face 100a also contains one or more dedicated and/or programmable buttons 75 for selecting information and causing the computer system to implement functions. Other buttons (icons) can be implemented within a silk screen layer material 84 on which regions 106a and 106b reside. An exemplary on/off button 95 is also shown.

FIG. 2A also illustrates a handwriting recognition pad or “digitizer” containing two regions 106a and 106b. Region 106a is for the drawing of alpha characters therein for automatic recognition (and generally not used for recognizing numeric characters) and region 106b is for the drawing of numeric characters therein for automatic recognition (and generally not used for recognizing numeric characters). The stylus 80 is used for stroking a character within one of the regions 106a and 106b. The stroke information is then fed to an internal processor for automatic character recognition.

FIG. 2B illustrates the bottom side 100b of one embodiment of the palmtop computer system. An optional extendible antenna 85 is shown and also an optional battery storage compartment door 90 is shown. A communication interface 108 is also shown. In one embodiment of the present invention, the serial communication interface 108 is a serial communication port, but could also alternatively be of any of a number of well known communication standards and protocols, e.g., parallel, SCSI, Firewire (IEEE 1394), Ethernet, etc. In FIG. 2B is also shown the stylus receiving slot or rail 350.

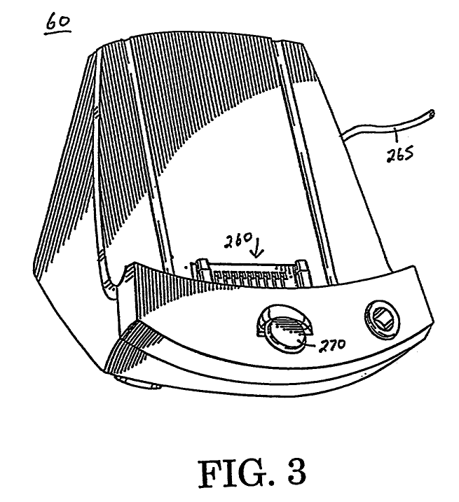

FIG. 3 is a perspective illustration of one embodiment of the cradle 60 for receiving a handheld computer system 100. In other embodiments, cradle 60 is not a stand-up device but is rather part of a cable connection between the palmtop computer system 100 and the desk top unit. Cradle 60 contains a mechanical and electrical interface 260 for interfacing with serial connection 108 (FIG. 2B) of computer system 100 when system 100 is slid into the cradle 60 in an upright position. Alternatively, a USB connection could be used. Once inserted, button 270 may be pressed to initiate two way communication between system 100 and other computer systems coupled to serial communication 265.

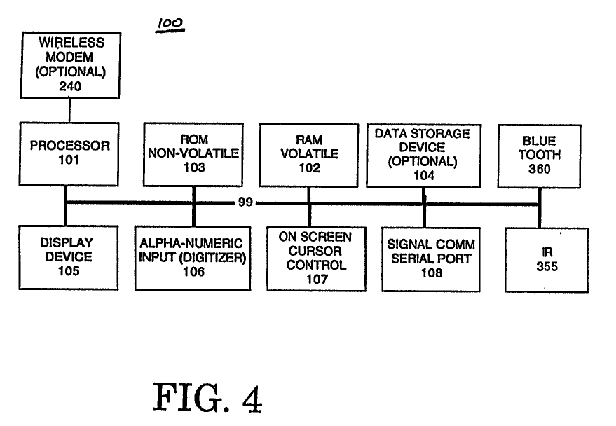

FIG. 4 illustrates exemplary circuitry of portable computer system 100. Computer system 100 includes an address/data bus 99 for communicating information, a central processor 101 coupled with the bus 99 for processing information and instructions, a volatile memory 102 (e.g., random access memory RAM) coupled with the bus 99 for storing information and instructions for the central processor 101 and a non-volatile memory 103 (e.g., read only memory ROM) coupled with the bus 99 for storing static information and instructions for the processor 101. Computer system 110 also includes an optional data storage device 104 (e.g., thin profile removable memory) coupled with the bus 99 for storing information and instructions. Device 104 can be removable. As described above, system 100 also contains a display device 105 coupled to the bus 99 for displaying information to the computer user.

Also included in computer system 100 of FIG. 4 is an alphanumeric input device 106 which in one implementation is a handwriting recognition pad (“digitizer”) having regions 106a and 106b (FIG. 2A), for instance. Device 106 can communicate information (spatial data and pressure data) and command selections to the central processor 101.

System 110 also includes an optional cursor control or directing device 107 coupled to the bus for communicating user input information and command selections to the central processor 101. In one implementation, device 107 is a touch screen device (also a digitizer) incorporated with screen 105. Device 107 is capable of registering a position on the screen 105 where the stylus makes contact and the pressure of the contact. The digitizer can be implemented using well known devices, for instance, using the ADS-7846 device by Burr-Brown that provides separate channels for spatial stroke information and pressure information.

The display device 105 utilized with the computer system 100 may be a liquid crystal device, cathode ray tube (CRT), field emission device (FED, also called flat panel CRT) or other display device suitable for creating graphic images and alphanumeric characters recognizable to the user. Any of a number of display technologies can be used, e.g., LCD, FED, plasma, etc., for the flat panel display 105. In one embodiment, the display 105 is a flat panel multi-mode display capable of both monochrome and color display modes.

Signal communication device 108, also coupled to bus 99, can be a serial port (or USB port) for communicating with the cradle 60. In addition to device 108, wireless communication links can be established between the device 100 and a host computer system (or another portable computer system) using a Bluetooth wireless device 360, an infrared device 355, or a GSM radio device 240. Device 100 may also include a wireless modem device 240 and/or a wireless radio, e.g., a GSM wireless radio with supporting chipset. The wireless modem device 240 is coupled to communicate with the processor 101 but may not be directly coupled to port 108. In one implementation, the Mobitex wireless communication system may be used to provide two way communication between system 100 and other networked computers and/or the Internet via a proxy server. In other embodiments, TCP protocol can be used or SMS (Short Message Service) can be used.

### Method and System for Using Tokens to Conduct File Sharing Transactions Between Handhelds Via a Web Server

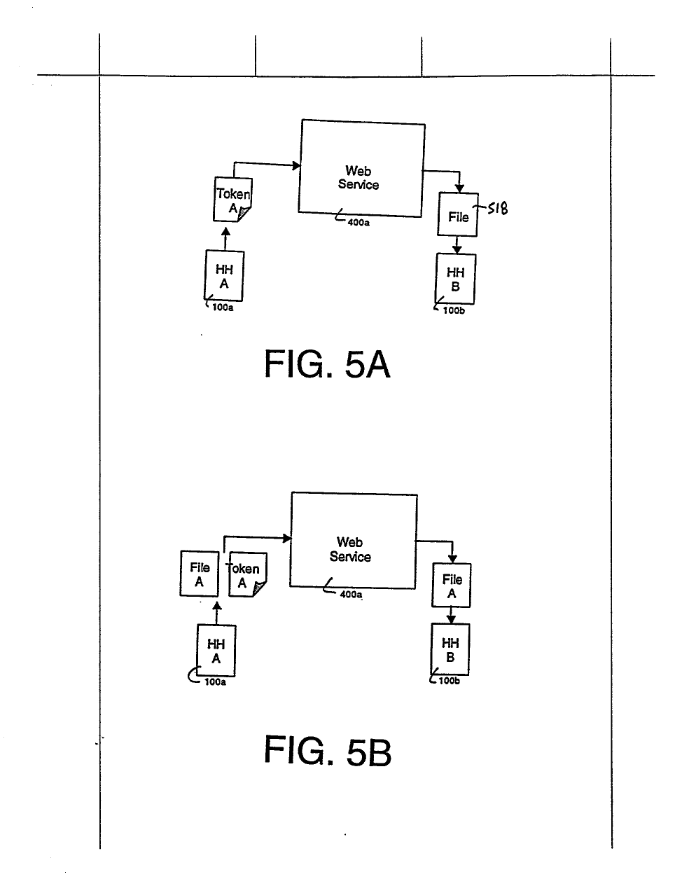

FIG. 5A illustrates a system in accordance with an embodiment of the present invention including a sending device 100a and a receiving device 100b. Embodiments of the present invention allow for a networked handheld 100a to share a file with another handheld device 100b, irrespective of its current proximity or availability to the handheld initiating the sharing (“the sending handheld” 100a).

Sharing occurs by the sharing handheld 100a passing a token (Token A) to a web server 400a. The token (Token A) contains information regarding the name of the file to be shared along with the identify of the receiving handheld. The token is a compact record which can be transferred over wireless networks in a much more efficient manner than sending the entire file. This would occur if the shared file did not already exist on the web service. The token is then used to update the account information (on the server) of the receiving handheld in order to cause a file download 518 to occur between the server 400a and the receiving handheld 100b when the receiver 100b next synchronizes with the server 400a.

FIG. 5B illustrates a variation of this process that allows for a networked handheld 100b to share a file (File A) directly, by uploading the file from the handheld along with the token (Token A). The file is then stored in an applications/file repository on the server 400a. The token is used to update the account information of the receiving handheld in order to cause a file download (File A) to occur between the server 400a and the receiving handheld 100b when the receiver 100b next synchronizes with the server 400a.

In yet another embodiment, an in-box of the handheld 100b receiving a file from another networked handheld 100a is updated to reflect the availability of a new file. The receiving handheld is alerted through a separately defined mechanism that could include email notification, or other altering mechanism. Subsequently, the receiver may click-on, or otherwise select, the name of the file in the in-box and it will be downloaded according to the rules defined by the user in the policy manager.

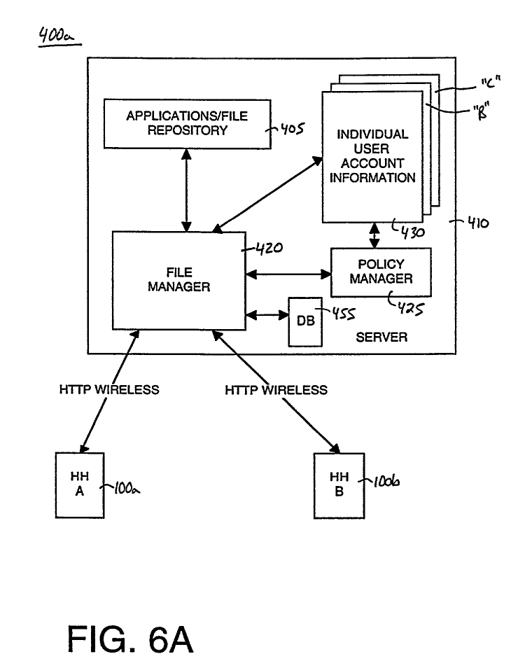

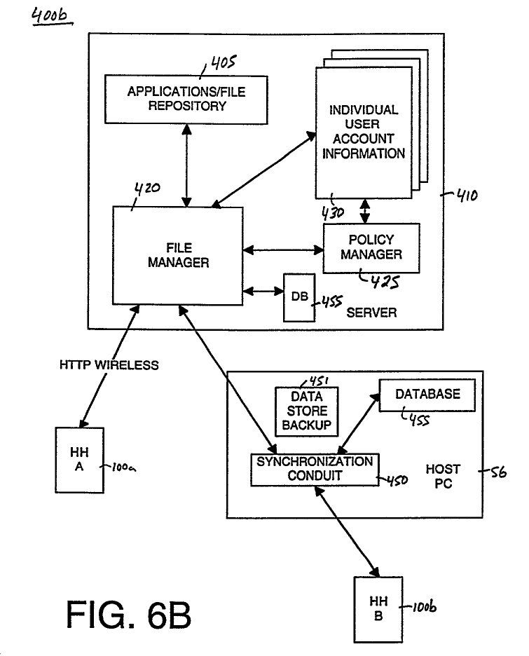

FIG. 6A illustrates a system 400a in accordance with an embodiment of the present invention for performing web file sharing between two or more handheld devices 100a and 100b, e.g., portable computer systems, using a remote server 410 acting as an intermediary to facilitate the transaction. In this example, the sending device is 100a and the receiver device is 100b, but either device is capable of both sending and receiving in accordance with the descriptions herein. As described in more detail below, multiple handheld devices can register with the server 410 to perform synchronization, file sharing and file transfer procedures.

The server 410 may be a web server, or any type of remote server that can be accessed by the handheld devices 100a, 100b. In the example of FIG. 6A, both devices 100a, 100b are capable of wirelessly connecting to the server 410, e.g., using HTTP protocol over any wireless network (e.g., GSM, Mobitex, etc.). FIG. 6B illustrates an example where a host computer 56 is used to provide the connection to the server for device 100b.

The server 410 of FIG. 6A and FIG. 6B contains a file manager 420 which is a software tool for providing file download services to the handheld device. The functions that comprise synchronization are well known in the art and any synchronization process can be used by the file manager 420. Generally, synchronization is the process of exchanging information between the database 455 located on the server and the internal databases of the handheld devices so that each database has the same information. This also functions as an effective back-up process. The general process and results achieved through synchronization, e.g., “hot sync” are described in more detail in the following: U.S. Pat. No. 5,727,202 issued Mar. 10, 1998 by Kucala; U.S. Pat. No. 6,000,000 issued Dec. 7, 1999 by Hawkins et al.; U.S. Pat. No. 5,832,489 issued Nov. 3, 1998 by Kucala; U.S. Pat. No. 5,884,232 issued Mar. 16, 1999 by Hawkins et al.; and U.S. Pat. No. 6,006,274 issued Dec. 21, 1999 by Hawkins et al., all of which are hereby incorporated herein by reference.

The server 410 of FIG. 6A and FIG. 6B also contains an applications/file repository or database 405. Database 405 maintains an instantiation of all applications that have been seen by the file manager 420 during synchronization and back-up procedures with the various handheld devices that register with the server. If the server 410 is used to obtain an application for downloading to a handheld, then that application would also be stored in the database 405. In addition to applications, database 405 may also contain any type of other information, e.g., data, images, etc. The file download manager 420 interfaces with database 405. One function of the download manager 420 is to determine which applications, or other data, of the applications repository 405 should be downloaded to a registered handheld. This function can be performed during a synchronization process between server 410 and the registered handheld.

The file download manager 420 also interfaces with a database of individual user account information 430 which is also a part of server 410. Database 430 includes a separate account for each registered handheld. The account is a short list that specifies the current applications, their version numbers and descriptions that are currently installed on the registered handheld. This information is updated on each synchronization procedure. The file download manager 420 interfaces with database 405 and database 430 to determine if updated versions of software, or other information, are available within database 405 for a particular registered handheld. This process is described in co-pending U.S. patent application Ser. No. 09/579,865, filed May 25, 2000, entitled “Automatic Selection and Updating of Software Application Version,” by Flores, McIlroy, and Lemke, assigned to the assignee of the present invention and hereby incorporated by reference.

As discussed more below, an account may also specify an application (or other information) that is to be installed on the registered handheld but is not currently installed therein. Using this technique, a sending handheld 100a can effectively send information to a receiving handheld 100b via the server 410 by merely updating the account information of a receiving handheld 100b. In this case, on the next synchronization process performed by the receiving device 100b, the new information may potentially be downloaded to it. Server 410 also contains a policy manager 425. The policy manager 425 enforces certain restrictions on the scope of allowable devices that may send information, via the server 410, to a particular receiving handheld. Alternatively, the policy manager 425 may also require user confirmation (on the receiving end) to complete transactions.

FIG. 6B illustrates system 400b that is similar to system 400a of FIG. 6A except that a host computer system 56 is used to establish the communication link between the handheld 100b and the server 410. In this case, the database 455 used to perform synchronization and back-up may be located on the desktop unit 56 in lieu of the server 410. In this case, a synchronization conduit 450 performs synchronization and back-up procedures between database 455 and the handheld 100b. Synchronization conduit 450 also interfaces with the remote server's file manager 420 in order to receive any downloaded information for the handheld 100b. It is appreciated that host 56 may be connected to the server 410 via a wired or wireless Internet connection. A data store backup 451 may be included in the host 56.

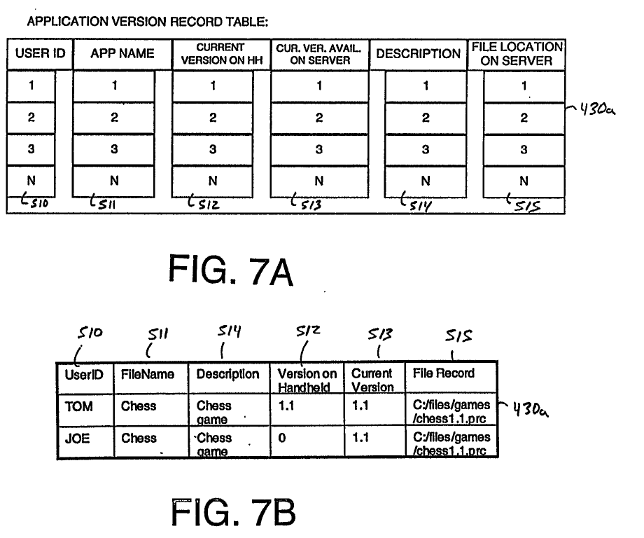

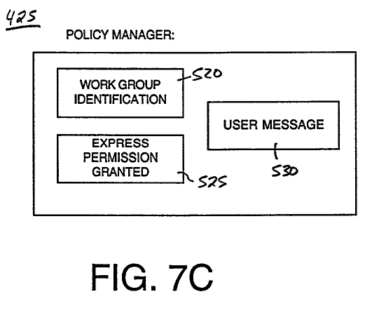

FIG. 7A illustrates an exemplary application version record table 430a which is stored in the remote server's individual account database for a particular handheld device, e.g., receiver 100b. The application version record table 430a includes multiple entries (e.g., 1-n). Each entry includes an application identifier (e.g., name) 511, its version number or identifier 512 that represents the most current version installed on the handheld 100b, its version number or identifier 513 that represents the most current version installed on the server, a short description of the application 514, its file location on the server 515, and an identifier of the source device (“user ID”) 510. Generally, the application version record table 430a includes an entry for each application, or other data file, that is stored in the handheld 100b.

Importantly, in accordance with the present invention, a sending device 100a may create a new entry in the table 430a of a receiving device in order to transfer information to the receiver 100b. In this case, the sending device's identifier will be placed in the user ID field 510 for the new entry. The application identifier (and version number) of this new entry will indicate an application, or other information, within database 405 that is to be downloaded to device 100b when device 100b next performs a synchronization with the server 410.

FIG. 7B illustrates an example table 430a for registered users “Tom” and “Joe.” In this example, “Joe's” registry (the second entry) illustrates that a newer version (1.1) of the chess game is available than the one that is installed on his computer (0). This could be a result of “Tom” sending “Joe” a token (via the server) that is going to install the chess game on “Joe's” computer.

More specifically, FIG. 7B provides an example use of the application version record table 430a in accordance with an embodiment of the present invention. In this example, user_ID “Tom” maintains a record for a chess game (the first entry) 514. When “Tom” requests to share his application with user_ID “Joe” (who previously granted share write access to “Tom”), a second record is established for User_ID “Joe” which mirrors the data in the record “Tom,” with the exception that the “Version on Handheld” Field 512 is set to zero. The next time user_ID Joe synchronizes the device, the file manager 420 will note the difference between the “Version on Handheld” field 512 and the Current Version field 513 and deliver the application denoted by the file record and stored in the application/file repository 405.

FIG. 7C illustrates the security definitions of the policy manager 425 in accordance with one embodiment of the present invention. The security definitions of FIG. 7C are pertinent to the receiving device 100b and each receiving device has its own security definitions. It is appreciated that this security information 425 may also be integrated within the receiver's account information of database 430, in one embodiment. The security definitions include a work group identification 520. Within 520 can be stored identifications of work groups and a listing of devices within that work group. Transaction permission can thereby be defined by the receiving device for groups of devices, rather than individual devices.

In addition, the security definitions include an express permission granted identification 525. Within 525 can be stored identifications of individual devices that have permission to conduct transactions with the receiving device 100b. Permission conflicts between 520 and 525 are generally resolved in favor of the express grants of 525. In the user message 530, user confirmation may be required to complete transactions regardless of the permissions granted in 520 and 525. In this case, a user message or cue may be stored in 530 and will be presented to the user of the receiver handheld 100b in order to allow downloads to complete. Specific user confirmation instructions may also be stored in 530. The user message 530 may indicate the source of the downloaded information.

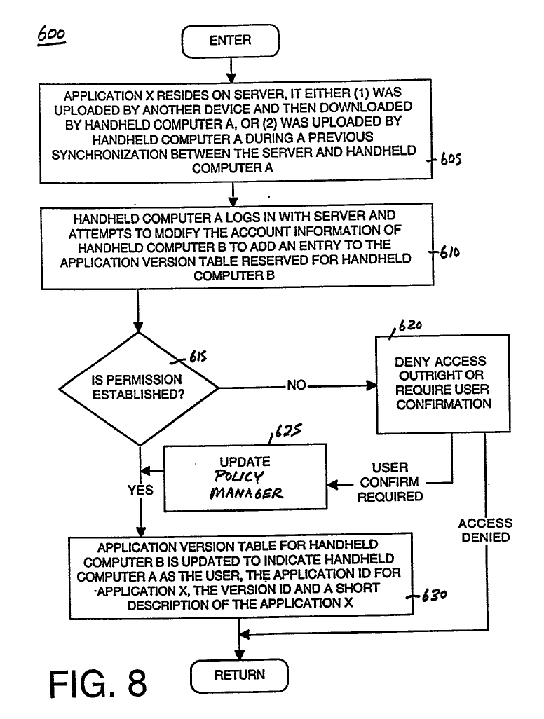

FIG. 8 illustrates steps of a computer implemented transaction process 600 as performed by a sender device in accordance with an embodiment of the present invention. It is appreciated that all of the steps of process 600 may be performed without the receiver device being in communication with the remote server. For sake of discussion, it is assumed that application X is to be transferred from a sender device to a receiver device. Application X could represent an application program or any identifiable information or data. At step 605, it is assumed that application X resides on the remote server. Application X may have been uploaded by another device and then downloaded to the sender handheld, or alternatively, application X could have been uploaded by the sender handheld computer during a previous synchronization between the server and the sender handheld.

At step 610, the sender handheld computer registers or otherwise accesses the remote server and attempts to modify the application version record table assigned to the receiver handheld. The sender handheld attempts to modify the table by adding an entry that will identify application X but will have a zero version number. This may occur by the sender sending a short token to the server that identifies the application, its version number and the receiver device. The token will then cause the table to be modified for the receiver by adding the entry described above. This entry will require that the application manager automatically download application X to the receiver handheld on its next synchronization with the server. The entry will also identify the sender handheld device and include a short description of application X.

At step 615, the policy manager on the remote server determines if the sender handheld has the authority to modify the application version record table of the receiver handheld. If so, then at step 630, the new entry is placed into the application version record table of the receiver handheld and process 600 terminates. If authorization is not found, then access to the record table may be outright denied (at 620) to the sender handheld, at which case process 600 terminates. Alternatively, at step 620, user authorization may be required as a default. In this case, the record table is allowed to be modified (step 630) but at step 625 the policy manager is updated such that the user of the receiver device will be required to make a confirmation before the transaction can be completed.

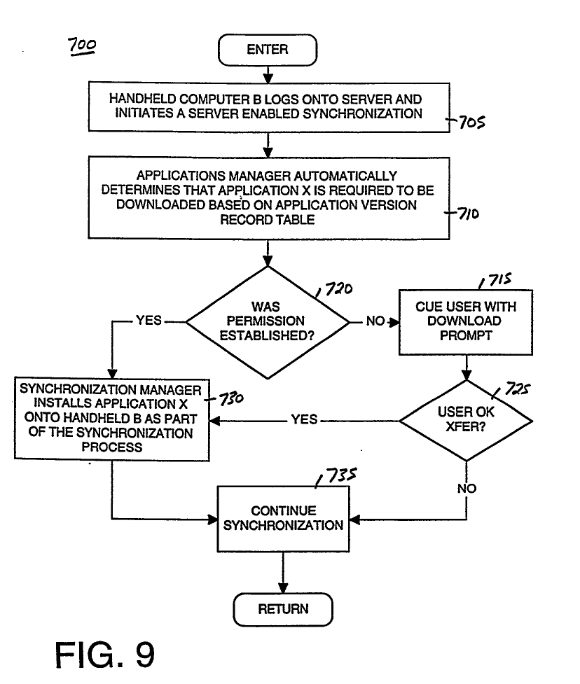

FIG. 9 illustrates steps of a computer implemented transaction process 700 as performed by the receiver device in accordance with an embodiment of the present invention. It is appreciated that all of the steps of process 700 may be performed without the sender device being in communication with the remote server. At step 705, the receiver handheld device accesses the remote server and initiates a synchronization procedure.

At step 710, the file download manager on the server automatically determines that application X is required to be downloaded to the receiver handheld. This is performed by the file download manager comparing the entries of the application version record table against the applications of the applications repository. If an application having a newer version number is stored in the applications repository (as compared to the entries of the application version record table), then that application is a candidate to be downloaded to the receiver handheld. It is appreciated that step 710 is performed whether synchronization is being performed with a server resident database (FIG. 5A) or with a host computer resident database (FIG. 5B). Because the entry that contained application X was recorded (by the sender) with a version number of zero, the file download manager will automatically determine that application X, having a greater version number, will need to be downloaded to the receiver handheld.

At step 720, the server determines whether or not appropriate authorization exists for the transaction to take place. The server compares the identification of the sender device against the policy manager of the receiver device. If permission is granted to the sender device and no user confirmation is required, then step 730 is entered where the application X is automatically installed onto the receiver device during synchronization. If permission was not established, or if permission was established but user confirmation is required, then step 715 is entered. At step 715, the user of the receiver handheld is given a message requesting confirmation for the download. If confirmation is given, then step 730 is entered, otherwise the download is not completed (step 735).

Accordingly, the transaction described by processes 600 and 700 allows file sharing between two or more handheld devices using a server as an intermediary. The download operation performed by step 630 is performed automatically without any requirements of the user to access special software tools or perform complex software operations. In effect, the download can be performed transparently to the user. The file sharing processes of the present invention are also advantageous because they can be applied to remotely located devices.

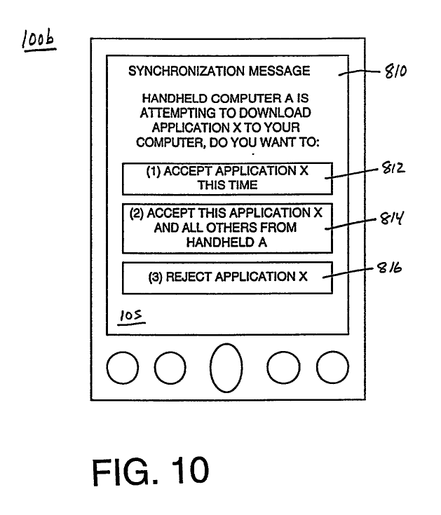

FIG. 10 illustrates an exemplary user message 810 that can be displayed on the receiver handheld 100b in response to step 715 (FIG. 9). The message includes an identification of the sender device and the application that is attempting to be downloaded. The user is given some confirmation choices. At 812, the user may accept the application X; at 814 the user may accept application X and also update the policy manager so that all applications from the sender device can be received without a user confirmation; or at 816 the application X may be rejected.

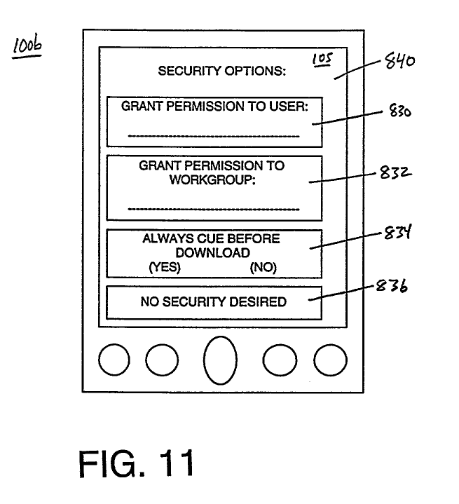

FIG. 11 illustrates exemplary user controlled security options 840 that may be employed by the receiver device 100b. These security options may be performed by the receiver handheld 100b at any time. These security options 840 directly update the policy manager of the server when device 100b next synchronizes with it. Any device name entered into field 830 will be added to the policy manager's definition 525 (FIG. 7C). Any work group name added into field 832 will be added to the policy manager's definition 520. At option 834, the user may indicate that all transactions require user confirmation as a precursor. Alternatively, all security techniques may be removed at field 836.

Using these security options, different security policies can be maintained between a sender and a receiver. For instance, under a first policy, a receiver (Tom) may give explicit permission to a sender (Joe) that information may be received from him. Joe then transacts by sending a token to the server to send a game to Tom. The game then appears in Tom's synchronization registry and can be downloaded to Tom's handheld on its next synchronization with the server.

Alternatively, under a second policy, no permission may be given ahead of time. In this case, Joe performs a transaction by sending a token to the server to give the game to Tom. The server then prompts Tom, e.g., by any alert mechanism, for acceptance. If accepted, the game then appears in Tom's synchronization registry and can be downloaded to Tom's handheld on its next synchronization with the server.

The preferred embodiment of the present invention, a method and system for using tokens to perform file sharing transactions involving a web server and two or more handheld computer systems, is thus described. While the present invention has been described in particular embodiments, it should be appreciated that the present invention should not be construed as limited by such embodiments, but rather construed according to the below claims.

1. A method of transferring information comprising the steps of:
a) at a remote server, responsive to a receiving signal from a first mobile computing device, accessing an account stored on said remote server, said account reserved for a second mobile computing device, said account describing information that is not stored in said second mobile computing device;
b) modifying said account to identify an information that resides on said remote server but not on said second mobile computing device;
c) responsive to establishing a connection with said second mobile computing device, said remote server automatically determining from said account that said information is new to said second mobile computing device, and in response to said determining, automatically downloading said information to said second mobile computing device.

2. A method as described in claim 1 further comprising the step of said remote server receiving a token identifying said information and said second mobile computing device, and wherein said token causes said account to be modified by said remote server.

3. A method as described in claim 1 wherein said first and said second mobile computing devices are portable electronic computer systems.

4. A method as described in claim 1 wherein said information is a version of an application program.

5. A method as described in claim 4 wherein said account comprises an application version record table comprising an entry for each application stored in said second mobile computing device and wherein each entry comprises: an application identifier; a version identifier; and a user identifier.

6. A method as described in claim 1 wherein said step of automatically downloading said information to said second mobile computing device, of step c), is performed only if said first mobile computing device has authority to download to said second mobile computing device.

7. A method as described in claim 6 wherein said authority is established via an express grant of permission from said second mobile computing device to said first mobile computing device.

8. A method as described in claim 6 wherein said authority is established via a user confirmation that is made in response to a user message displayed on a display screen of said second mobile computing device.

9. A method as described in claim 1 wherein said remote server is a web based server.

10. A method as described in claim 1 wherein said step d) is performed within a synchronization process between said remote server and said second mobile computing device.

11. A method as described in claim 1 wherein said step d) is performed within a synchronization process between a host computer system and said second mobile computing device.

12. A system comprising:
a receiver mobile computing device;
a remote server containing an account reserved for said receiver mobile computing device which describes a complement of information stored in said receiver mobile computing device;
a sender mobile computing device for causing said account to be modified to identify an information that resides on said remote server but not on said receiver mobile computing device;
wherein said receiver mobile computing device is for establishing a connection with said remote server; and
wherein said remote server is for automatically determining, from said account, that said information is new to said receiver mobile computing device and automatically for downloading said information to said receiver mobile computing device.

13. A system as described in claim 12 wherein said sender mobile computing is for sending said remote server a token identifying both said information and said receiver mobile computing and wherein said token causes said remote server to modify said account.

14. A system as described in claim 12 wherein said sender and said receiver mobile computing devices are mobile computing computer systems.

15. A system as described in claim 12 wherein said information is a version of an application program.

16. A system as described in claim 15 wherein said account comprises an application version record table comprising an entry for each application stored in said receiver mobile computing device and wherein each entry comprises: an application identifier; a version identifier; and a user identifier.

17. A system as described in claim 12 wherein said remote server is also for determining if said sender mobile computing device has authority to download to said receiver mobile computing device as a precursor to downloading said information to said receiver mobile computing device.

18. A system as described in claim 17 wherein said authority is established via an express grant of permission from said receiver to said sender mobile computing device.

19. A system as described in claim 17 wherein said authority is established via a user confirmation that is made in response to a user message displayed on a display screen of said receiver mobile computing device.

20. A system as described in claim 12 wherein said remote server is a web based server.

21. A system comprising:
a receiver mobile computing computer;
a web based server containing an account reserved for said receiver mobile computing computer which describes a complement of information stored in said receiver mobile computing computer;
a sender mobile computing computer for causing said account to be modified to identify an information that resides on said web based server but not on said receiver mobile computing compute;
wherein said receiver mobile computing computer is for establishing a connection with said web based server; and
wherein said web based server automatically determines, from said account, that said information is new to said receiver mobile computing computer, also determines if said sender mobile computing computer has authority to download to said receiver mobile computing computer, and if so, automatically downloads said information to said receiver mobile computing computer.

22. A system as described in claim 21 wherein said sender mobile computing is for sending said remote server a token identifying both said information and said receiver mobile computing and wherein said token causes said web based server to modify said account.

23. A system as described in claim 21 wherein said information is a version of an application program.

24. A system as described in claim 21 wherein said account comprises an application version record table comprising an entry for each application stored in said receiver mobile computing computer and wherein each entry comprises: an application identifier; a version identifier; and a user identifier.
